(19) United States
(12) Patent Application Publication
(10) Pub. No.: US 2003/0146341 A1
(43) Pub. Date: Aug. 7, 2003

(54) Shock ( Wave) Absorber

(76) Inventor: Eric Thomas Schmidt, Wichita, KS (US)

Correspondence Address: Eric T. Schmidt, 524 Commerce, Wichita, KS, 67202, US

(21) Appl. No.: 10/198,369

(22) Filed: Jul. 18, 2002

Related U.S. Application Data
(60) Provisional application No. 60/306,513, filed on Jul. 18, 2001.

(51) Int. Cl. B64C 1/00

(52) U.S. Cl. 244/1 N

(57) ABSTRACT

The Shock Wave Absorber is an inverted, rotated sinusoidal form inserted in the foremost tip of a vessel traveling in a fluid, with an opening to the nose, which provides orientation for turbulent air, water, etc . . .

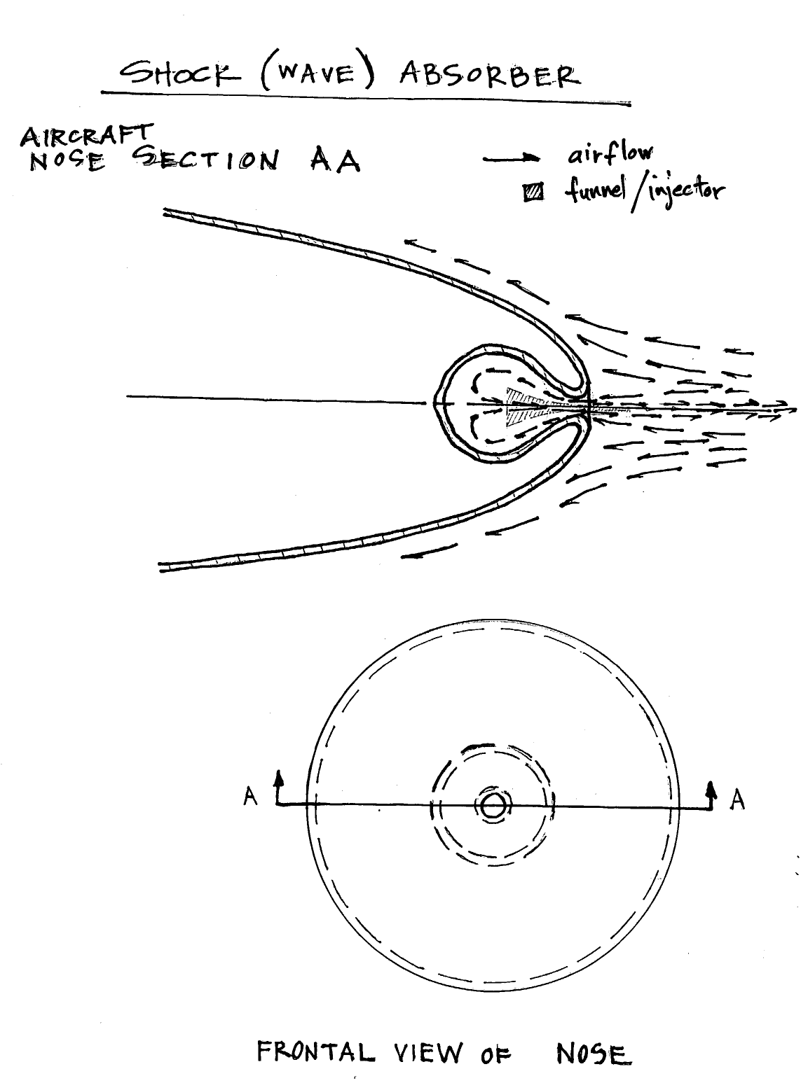

The Shock (Wave) Absorber is to be applied to the nose of aircraft. Toward the forward most tip of the nose, will be a concave sinusoidal rotation/inversion This sphere-like form concealed within the nose of the aircraft will be ported to the tip only. In motion, high pressure waves of air will compress within the Shock (Wave) Absorber and release through the same small port in which it entered, however, due to the cyclical movement of air through the port, the air will have spiral order and less turbulence. This spiral of air will precede the aircraft, bringing order to the air a distance in front of the tip of the aircraft.

An accessory to supersonic aircraft, would be an inserted trumpet shape, with bell end inside sphere-shape and the small end protruding the port. This funnel-type fairing may also contain an injector for gas to induce a mixed reaction to adjust the intersection with the sound barrier.

### DESCRIPTION OF SHOCK (WAVE ABSORBER DRAWING

Section AA shows airflow with regard to Shock Absorber. The pressure differential between the shock absorber and the outside air will equalize through spiral motion as does the flush of a toilet. The trumpet-shaped application may be used in conjunction with a gas injector to affect the penetration of the sound barrier. (This drawing is one of several workable designs to be elaborated upon in the formal patent application.)

What I claim as my invention is:

1. A forced rotated sine wave perspective cavity for bending turbulent waves occurring at the tips of air/water craft, tuning the closed system fuselage with infinity producing an ultimate harmonic, for maximum efficiency.
